(19) United States
(12) Patent Application Publication
(10) Pub. No.: US 2025/0117409 A1
(43) Pub. Date: Apr. 10, 2025

(54) Method of Searching Building Codes

(71) Applicant: UpCodes, Inc, San Francisco, CA (US)

(72) Inventors: Jonathan Wilson, Walnut, CA (US); Daniel Boghean, Philadelphia, CA (US); Scott Reynolds, Mill Valley, CA (US); Garrett Reynolds, Austin, TX (US)

(73) Assignee: UpCodes, Inc, San Francisco, CA (US)

(21) Appl. No.: 18/482,423

(22) Filed: Oct. 6, 2023

(51) Int. Cl. G06F 16/31; G06F 16/35; G06F 40/284

(52) U.S. Cl. CPC G06F 16/322; G06F 16/353; G06F 40/284

(57) ABSTRACT

Embodiments of this invention comprise a series of method steps for the specific purpose of searching and comparing different Building Codes. The steps are highly specific to the structure of Codes and terminology and organization of terms of art, such as “occupancy groups,” “construction types,” “building stories,” “capacity factors,” and the like. Input building codes are existing published codes, identified as “backbone codes.” Multiple backbone codes are compared using Levenshtein distances of text groups and matching code section titles and occupancy groups, using optional filters and search methods. Comparisons and comparison figures are output, with explanations.

### BACKGROUND OF THE INVENTION

Building Codes are adopted by jurisdictions, such as states and cities. These Codes vary over time and by jurisdiction. Determining applicable codes and their impact on building designs is a complex, time-consuming, and error-prone process, typically done by architects, technical consultants, engineers, and building contractors. Government planning departments and inspectors also need access to both current and past Codes, and often Codes from other jurisdictions.

In the prior art there is no simple or consistent way to search Building Codes. Key words may appear in hundreds of places. Section numbers and section names are not consistent. Many Codes do not have an Index or Table of Contents; if they do, they are likely not comprehensive. The Codes themselves rarely indicate changes from either earlier Codes or Parent Codes from which the applicable Code is derived.

### SUMMARY OF THE INVENTION

Embodiments of this invention overcome the weaknesses of prior art.

Embodiments of this invention comprise a series of steps for the specific purpose of searching and comparing different Building Codes. The steps are highly specific to the structure of Codes and terminology and organization of terms of art, such as “occupancy groups,” “construction types,” “building stories,” “capacity factors,” and the like.

The term, “code” or “Code,” refers to a building code or similar document: printed, digital, or electronic.

A “backbone building code” is a “top level” document (printed or electronic) generated by a standards group, committee, or a state, for example. Typically, such a code from a standards body is adopted by a city or other jurisdiction at which point it becomes law or regulations. Embodiments of this invention work with such laws or regulations, rather than standards documents. These backbone codes are often referred to as “parent codes” or “ancestor” codes. They may be adopted as-is by a jurisdiction, such as a city. Often, however individual jurisdictions will modify the parent code by additions, deletions, or changes. These new codes are often called “child codes” or “descendent” codes.

Key steps in claimed embodiment methods, (“embodiments”) include first identifying one or more relevant parent codes and then one or more child codes derived from these parents. One may view such relations as a hierarchical tree graph structure. Creating and building an applicable code tree are key claimed methods. Such hierarchical trees exist for both codes as a whole and for specific sections, titles, requirements, aspects of a building (such as height limits), tables, equations, references to other documents and regulations, drawings and figures, text phrases and key words, for examples. Searching and comparing such highly variable and art-specific terminology and code elements requires special method tools and steps. For example, section numbers, section titles, and text must be each treated separately.

Similarities of section numbers, section titles, and text blocks are each compared using metrics such as Levenshtein distance. These metrics are then compared against a distance threshold to determine corresponding elements between two codes, for both codes at the same hierarchical level (e.g., two parent codes) and for codes in a parent-child relationship. These correspondences are then used to create a “map” comprising a sequence of correspondences to traverse a relevant code tree. For example, starting with a first child code its first parent code is identified. Then the first parent code is linked to a second parent code, and from there to a specific second child code. For example, the first child code may be the City of New York, which has a first parent code the State of New York, which as correspondence to a second parent code for the State of Illinois, and then to a second child code for the City of Chicago. Such a traverse of codes may be necessary, for example, if an architecture firm is in Chicago for a building to be in New York City.

Method steps may be organized into an “Input Phase,” “Output Phase”, “Explainer Phase” and a “Corresponder,” as well as other phases, text, comments, diagrams, and tags. An Input Phase may be used to enter key building data, such type, stories, and floor area. Validation steps may be performed in or between any phase. An Output Phase, from an embodiment, may then identify the relevant code sections in one or more building codes. An Explainer Phase, also from an embodiment, explains how the correspondence was created. Notes, links, tags, and arrows may also be created from embodiments to assist in the understanding and use of different code sections on related topics. Embodiment-created filters may be used to select specific relevant diagrams and illustrations from codes. Detailed steps and detailed text or other data, are not necessarily part of an output. Such steps or data may be “behind the scenes” or “internal” method steps. “Correspondence” is a core data relationship that may be used as part of numerous method steps or data structures, as one trained in the art knows.

Code sections are critically relevant to a specific “occupancy group.” Such occupancy groups may be for residential or for medical zoning, for example. It is critical to be sure that any comparisons apply to the same or most closely related occupancy group. Fire safety systems, for example, are different for different occupancy groups. Related method steps are complicated by the fact that occupancy group identifiers, such as “F-2” or “H-1” are often not identical across different codes.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an exemplary relationship of three backbone codes.

FIG. 2 shows an exemplary relationship of set child codes to backbone codes.

FIG. 3 shows key elements of the structure of building code sections.

FIG. 4 shows key elements in the comparison of two building code sections.

FIG. 5 shows a screenshot of a representative explanatory material attached to code sections.

FIG. 6 shows a screenshot of a representative explanatory diagram attaching to multiple sections with tags.

FIG. 7 shows a screenshot of Filters based on what sections of codes illustrations attach to.

FIG. 8 shows a screenshot of a comparison of related sections from two different codes.

FIG. 9 shows a screenshot of a representative Dynamic Input Page during an Input Phase.

FIG. 10 shows a screenshot of representative Building Code Validation during an Input Phase.

FIG. 11 shows a screenshot of a representative Summary of Output.

FIG. 12 shows a screenshot of a representative Dynamic Explainer.

FIG. 13 shows a screenshot of a representative output of a code-specific search engine.

FIG. 14 shows a screenshot of a representative BIM building code validation for 3D building elements.

FIG. 15 shows a screenshot of a first representative 3D model creations and 3D intersection checking.

FIG. 16 shows a screenshot of a second representative 3D model creations and 3D intersection checking.

FIG. 17 shows a screenshot of a third representative 3D model creations and 3D intersection checking.

FIG. 18 shows a screenshot of a representative Ingester.

### DETAILED DESCRIPTION

Scenarios and options are non-limiting embodiments.

An essence of embodiments includes a method of searching building codes, a method of matching text sections of two building codes, and a method of relating text sections of two building codes.

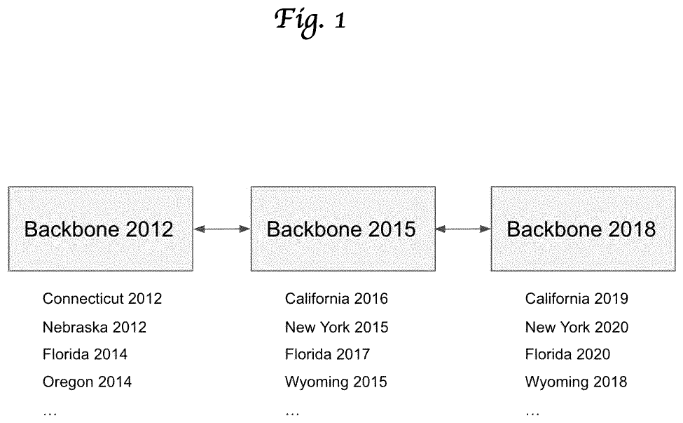

FIGS. 1-4 show block diagrams key claim elements

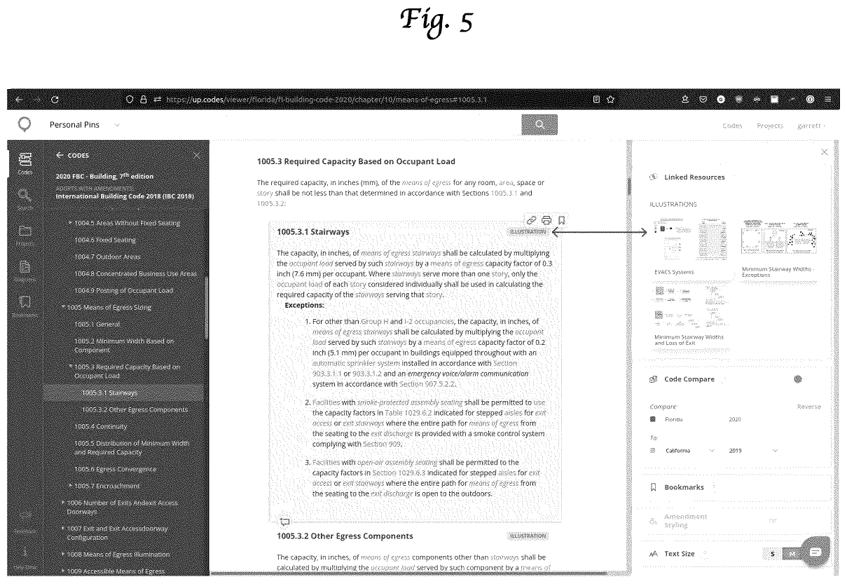

FIGS. 5-18 show exemplary screenshots demonstrating the method steps of claims of some embodiments.

Building and other codes use different terminology. Therefore, embodiments search for and resolve ambiguities and contractions. Such terminology and steps are highly specific to architecture and engineering construction (AEC). Associations and explanations will vary by building type and specific jurisdictions and dates. Explanations are synthesized by embodiments from the relevant and selected codes themselves, rather than being predetermined.

Turning first to FIG. 1, we see an exemplary relationship of a set of child codes to backbone codes. Here we see three different backbones, or parents, or ancestor codes that differ by year. These might for any different code class, such as building codes or plumbing codes. The code class is not shown. Underneath each backbone, or parent code, are set of child codes, such as Connecticut 2012, Nebraska 2012, et cetera. These child codes are derived from the above parent code. For example, the state of Connecticut may have adopted the backbone 2012 code, but with changes. Note that years of the backbone codes need not be the same year that a child code was adopted. For example, in 2017 Florida adopted, with changes the backbone code of 2015. Thus, to properly create and traverse multi-jurisdictional code trees it is necessary to know not only the year a code was adopted, but upon which parent code it was based.

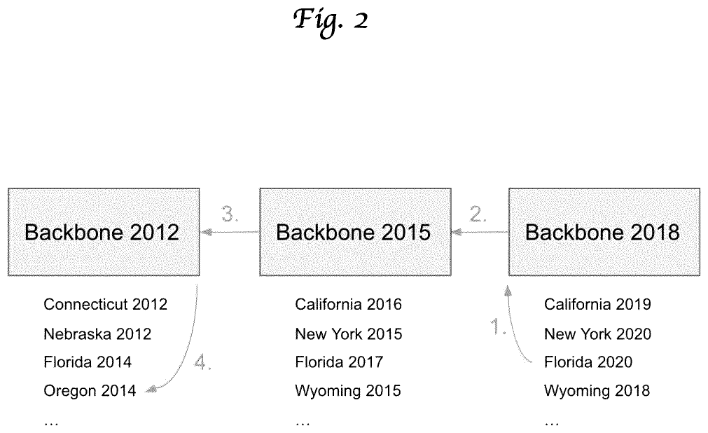

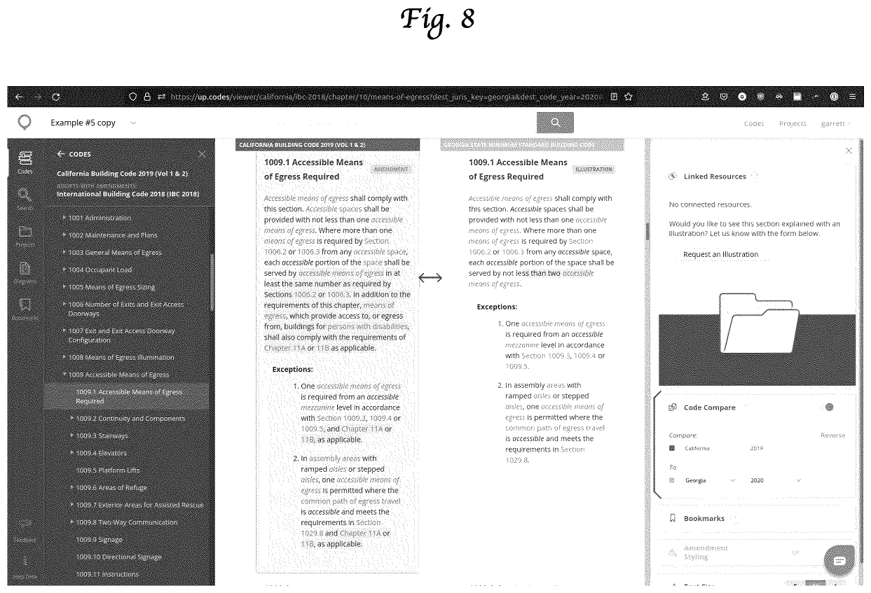

Turning now to FIG. 2, we see a traverse of the hierarchical code tree shown above in FIG. 8. This code tree must be traversed to compare two or more codes to each other. For example, to compare Florida 2020 to Oregon 2014 it is necessary to first identify the parent code for Florida 2020, which is backbone 2018, as shown by arrow 1. We then traverse across backbone codes to backbone 2012, shown by arrows 2 and 3. We then find the child code Oregon 2014 under the backbone 2012. Such “upward,” “sideways” and “downward” code tree traversal to establish a link between two child codes with different parents is a key method step in claimed embodiments.

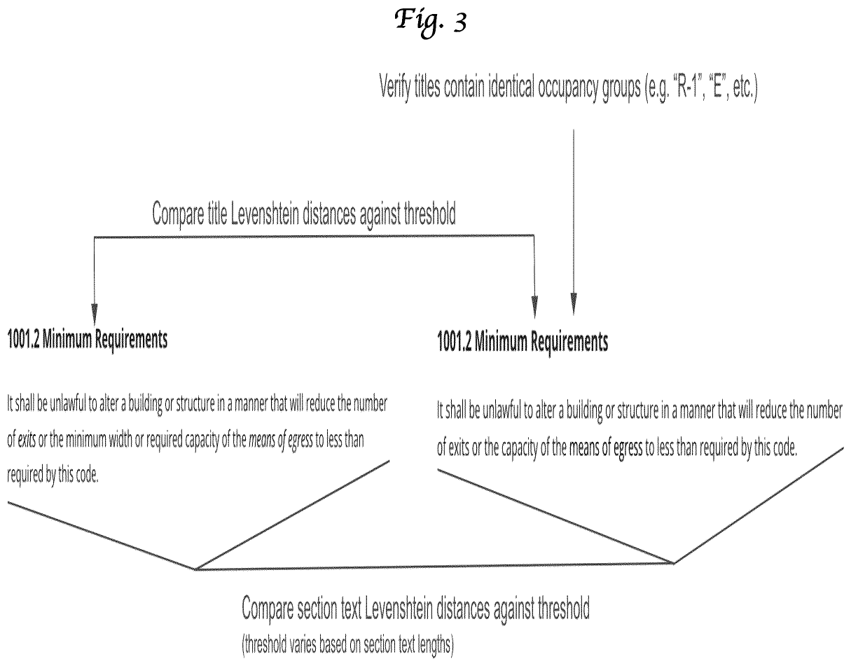

Turning now to FIG. 3, we see a schematic block diagram of key elements including an alphanumeric section heading, a section title, and the corresponding section text. We also see a reference to the applicable occupancy group; here “R-1.”

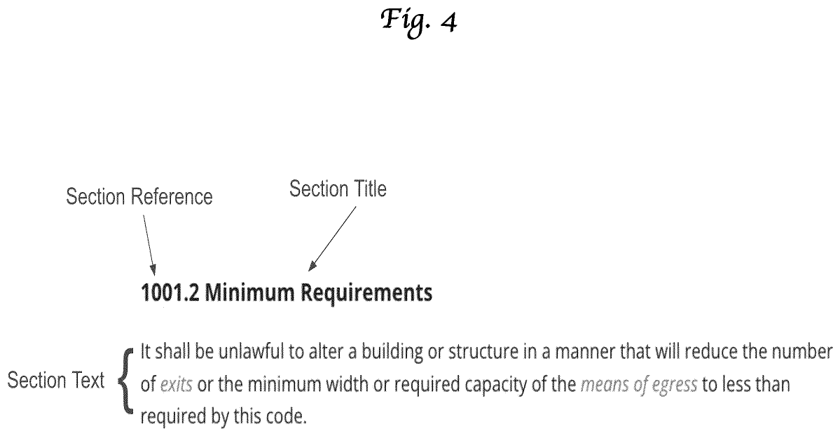

Turning now to FIG. 4, we see a schematic block diagram of two section titles being compared using Levenshtein distances of the text strings of the section titles. We also see the verification that the section titles contain identical occupancy groups. We also see the two section texts being compared using Levenshtein distances of all the section texts.

Turning now to FIG. 5, we see a screenshot of a representative relevant explanatory material and exact quotations from code. The code sections are presented in a dynamic hierarchical structure on the left pane. The main pane shows quotations from a code section, such as “1005.3.1 Stairways.” Key words, phrases and references are enhanced by changes to type or font. Such enhancements are not part of codes, but rather are computed from method steps of claimed embodiments. In addition, we see clearly marked links to related material, such as illustrations. Please refer to red arrows and links in green boxes. Such automatically computed emphases may be computed for many code sections, an exemplary portion of which are shown in the left pane.

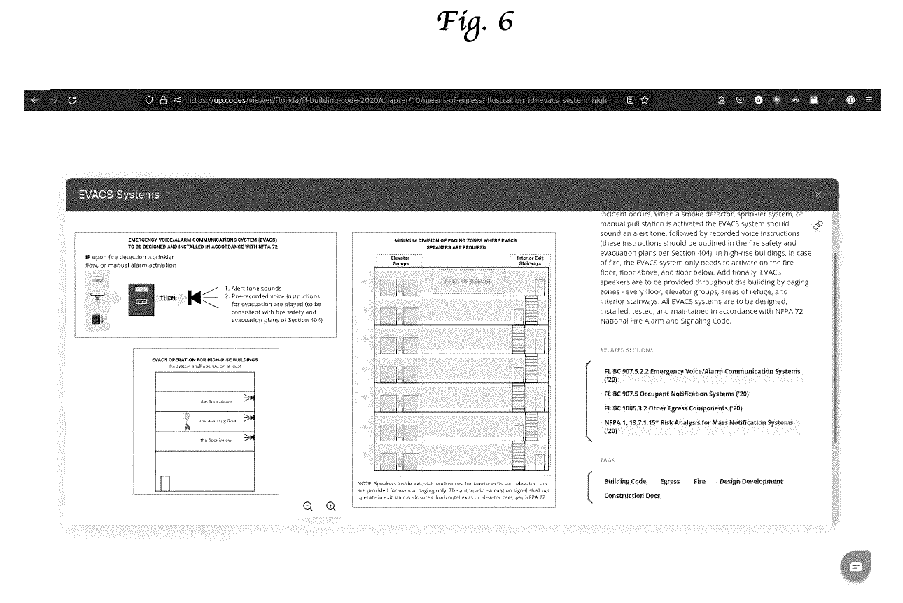

Turning now to FIG. 6, we see a screenshot of a representative explanatory diagram referencing to multiple sections with tags. Here we see in the upper left box an illustration for audio requirements for Emergency Voice/Alarm Communication System (EVACS). We also see in the same screenshot an illustration of Minimum Division of Paging Zones where EVACS Speakers are required. We also see in the right column a list of related sections from different codes, such as NFPA (2020). Codes rarely reference sections from different codes or codes from other jurisdictions. Rather, these are computed from method steps of claimed embodiments. We see in the lower right simple tags to identify search terms, for example. Here we see, “Egress,” “Fire,” and “Construction Docs.” Such tags are useful for numerous purposes, such as directing information to the appropriate employee, planner, or consultant. They also suggest non-code aspects that may need further review, such as “Construction Docs.”

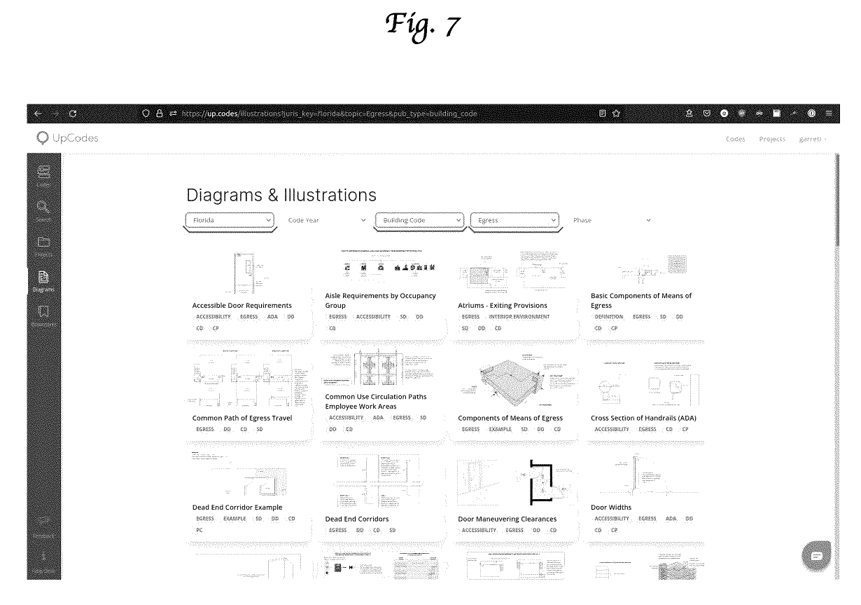

Turning now to FIG. 7, we see an exemplary screenshot of Filters based on validated data entered, specialized, novel code searching tools, and identified tags. Convenient for fast reference, diagrams from multiple codes are presented together. Tags used in the filtering process are also clearly shown at the bottom of each diagram or illustration. We see primary searching filters at the top. For example, here we see for the state of Florida, Building Codes, related to Egress. A user may alter search or filter criteria here to rapidly see other relevant diagrams and illustrations, as well as to compare to other codes, such as codes adopted by states other than Florida.

Turning now to FIG. 8, we see a screenshot of a comparison of related sections from two different codes. Such two codes might be from a code traverse, such as described above with FIG. 2. In the main pane we two columns, one for each code being compared. In the left column we see a portion of the “California Building Code 2019 (Vol 1 & 2).” In the right column we see a portion of the “Georgia State Minimum Standard Building Code.” Note how the titles of the codes differ by more than just the name of the state. Each of the two codes has a section numbered 1009.1 and named, “Accessible Means of Egress Required.” Despite the numbers and names of the sections being the same, the text of the code, exceptions, and associated material such as amendments and illustrations are significantly different. The far left pane identifies the code hierarchy for sections currently being displayed in the main pane. The far right pane provides navigation to other codes or other code sections.

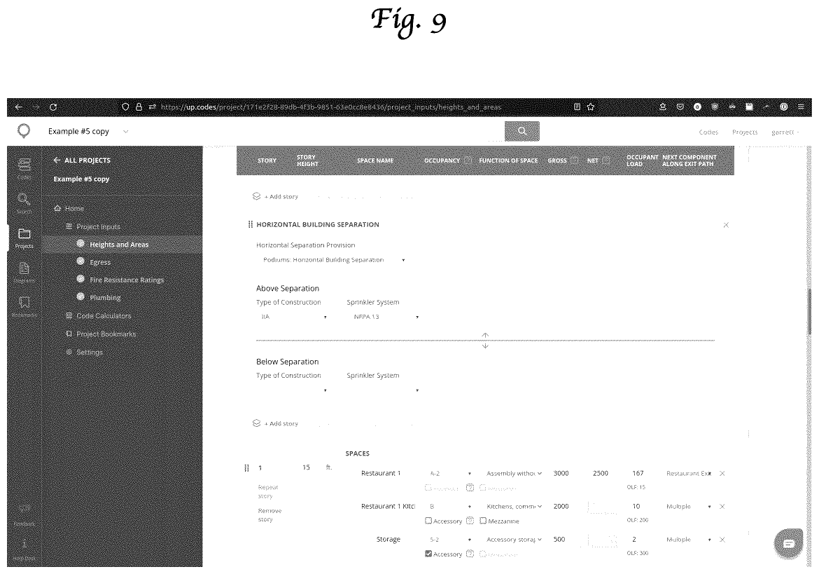

Turning now to FIG. 9, we see a screenshot of a representative Dynamic Input Page during an Input Phase. On a left pane we see various inputs that may be manually or automatically entered, such as from a Building Information Model (BIM) system. Here we see Heights and Areas, Egress, Fire Resistance Ratings, and Plumbing, as a non-exhaustive set. Note that these inputs do not directly correspond to any particular building code or code section. For example, a number of building stories may be information used in hundreds of different code sections. For Heights and Areas inputs, we see on the main pain particular parameters, such as Horizontal Building Separation, Type of Construction, Spaces including usage or a convenient name, occupancy codes, and other key information regarding building uses.

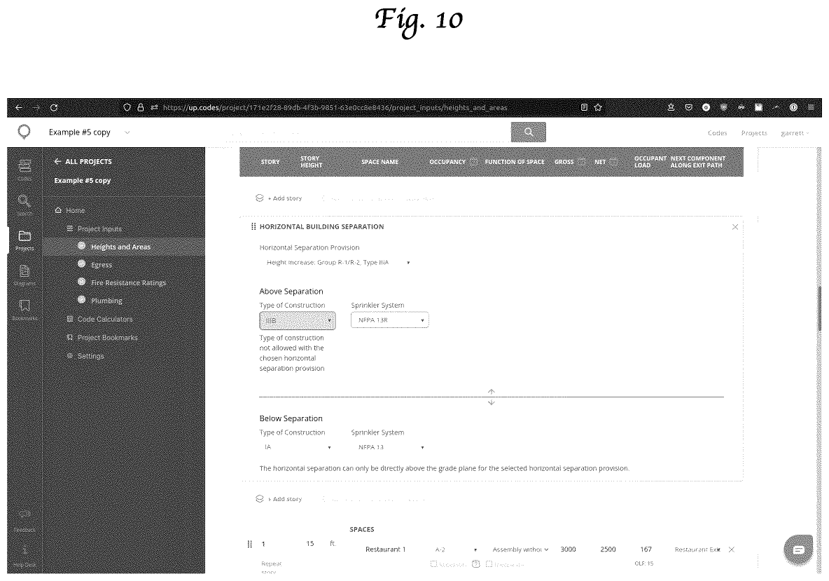

Turning now to FIG. 10, we see a screenshot of representative Building Code Validation during an Input Phase. Data entered may not be internally consistent, or inconsistent with basic code requirements. Here we see a warning in red, “Type of construction not allowed with the chosen horizontal separation provision.” In addition, we see an explanation of a problem, “The horizontal separation can only be directly above the grade plane for the selected horizontal separation provision.” Note that these errors and explanation are typically not explicitly or directly derived from code text. For example, a configuration may be “not allowed” because there is no entry for it in a table. Similarly, explanations of problems and their solutions are rarely in codes directly, as codes explain what is required, not how to achieve it. Such validations and recommendations are not obvious from codes and typically not obvious to an average person trained in the art (POSITA).

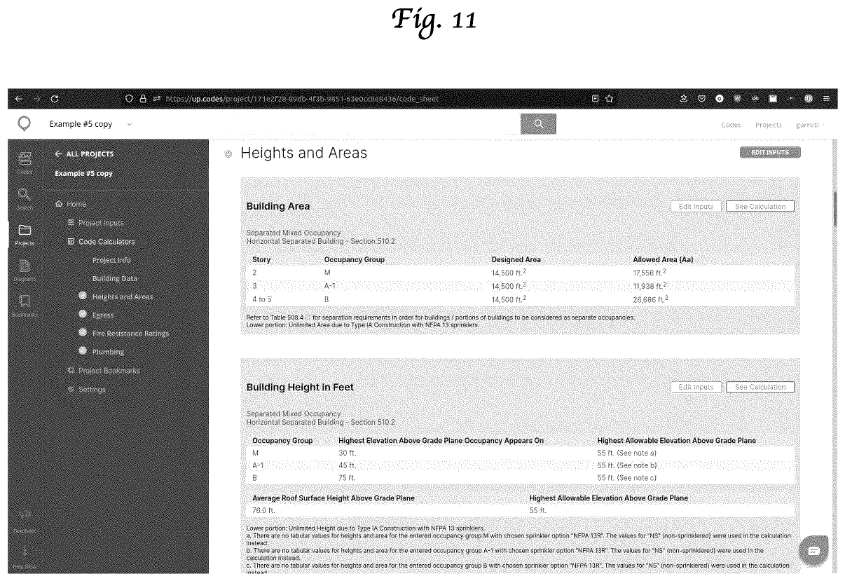

Turning now to FIG. 11, we see a screenshot of a representative Summary of Output. From the left pane we see what is included in a “code calculator,” an element of claimed embodiment. Within the colored blocks in the main pane, we see a clearly presented summary of building areas by story and occupancy groups. This information has already passed a basic validation step, above. The information is keyed by the most relevant code sections applicable. For example, for Building Area, we see references to “Section 510.2” and “Table 508.4.” In addition, hot links are provided that may take a user directly to the stated applicable code section or table. Codes do not provide hot links. In addition, we see relevant comments, such as (a.) through (c.) Codes do not provide such information on what might be enabled or what might be missing in the code.

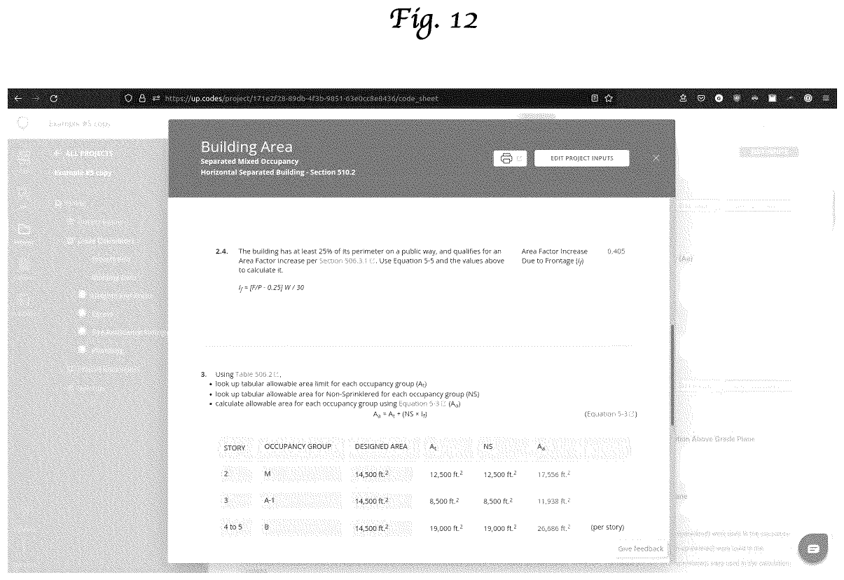

Turning now to FIG. 12, we see a screenshot of a representative Dynamic Explainer. Here we see explanations linked directly to details within a code section. For example, for section 2.4 we see both a reference to code Section 506.3.1 including a hot link. We also see an equation (Equation 5.5) from the code, with the appropriate values as entered and validated above to show the numerical result of this this formula applied.

We also see in FIG. 12, using Table 506.2, both an equation (Equation 5-3) with a table. A (a) has been automatically calculated and presented in tabular form. This information is not contained directly in any code section, and therefore is not mere presentation of information but rather the result of specific method steps in claimed embodiments. Note also that all such information presented is not data in isolation, but rather is directly tied to physical elements, such as buildings and floors. Note also that such data is critically tied to occupancy groups such as M, A-1, and B. Occupancy groups vary by jurisdiction and code. Therefore, such a table is likely not the same in different jurisdictions. Codes, as adopted, rarely reference other codes, such as codes for other jurisdictions. Thus, again, such information is not mere display of information, but rather is the result of claimed method steps for embodiments.

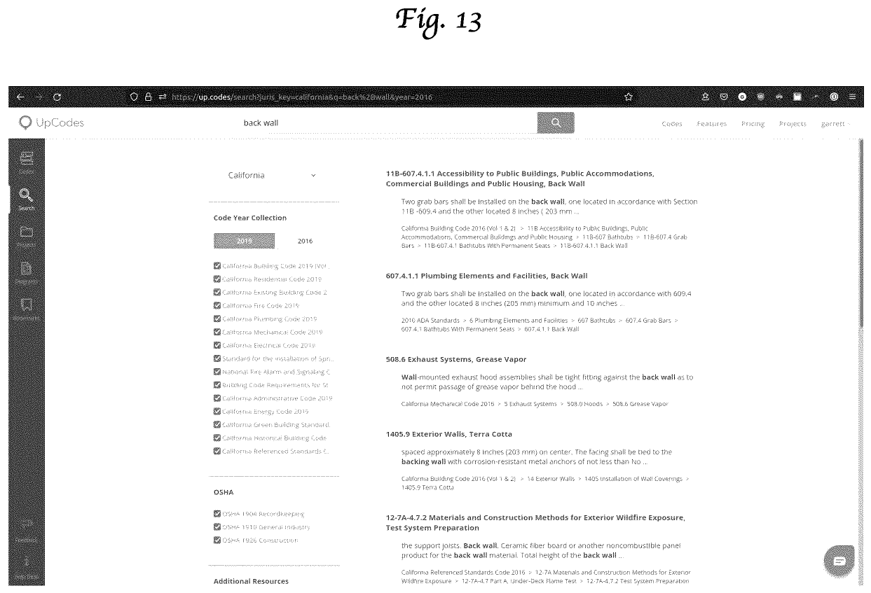

Turning now to FIG. 13, we see a screenshot of a representative output of a construction-specific search engine. In this example, we see code sections that contain the tag or key-phrase “back wall.” An architect, planner or contractor may easily use this construction specific search engine to easily find the relevant code sections for a “back wall.” Each code fragment quoted is identified, in blue, by the code section number and title. Each code fragment also provides the full hierarchical path to this fragment, within the applicable code, as shown in gray. On the left of this figure, we see a list of relevant codes used in the search. Note the relatively large number of different codes. We see also three government regulatory codes from OSHA. Note that some relevant or related codes may be very much older that the date of a building code. For example, “OSHA 1904 Recordkeeping.” Note that a use may enter search tags or phrases in the top search box. They may also select states and years to narrow the search.

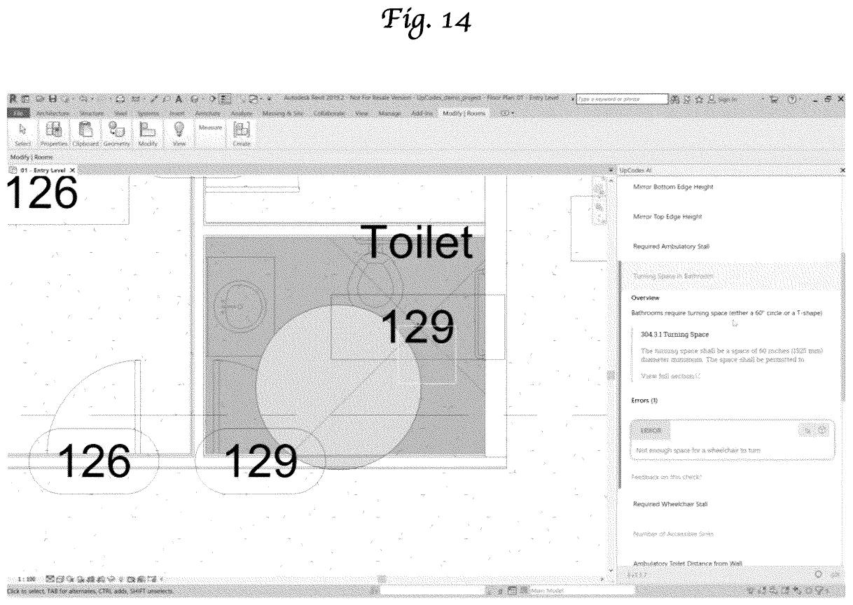

Turning now to FIG. 14, we see a screenshot of a representative BIM building code validation for 3D building elements. Here we see an exemplary review of turning space in a bathroom, typically to accommodate a wheelchair. An automated BIM building code validation embodiment identified that the turning space diameter, the yellow circle, is not contained within the floor area, shown in blue. The error is described in the right pane. In this example, the code requirement of a clear turning circle diameter is overlayed on a specific construction drawing. It is easy to see that not only is the floor area insufficient, but also a necessary turning circle is interfered with by the toilet, sink and door swing. The interference problem shown in this Figure is discovered automatically by claimed embodiments.

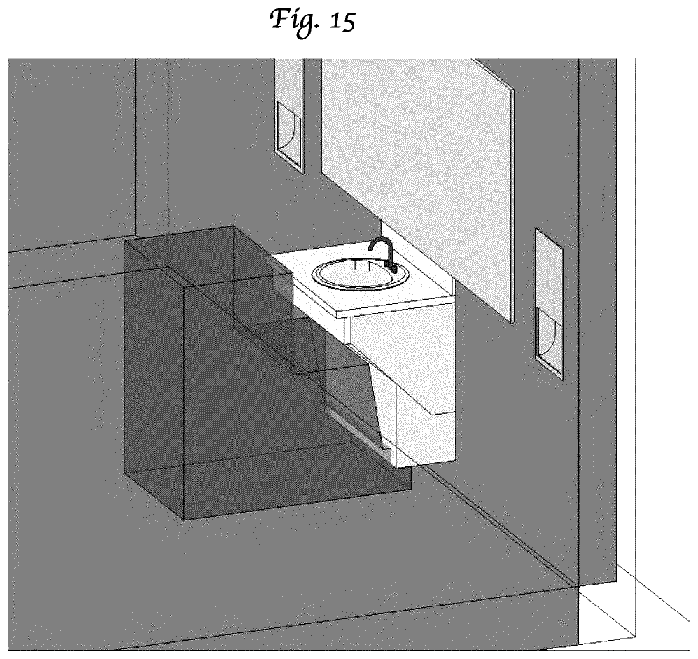

Turning now to FIG. 15, we see a screenshot of a first representative 3D model creations and 3D intersection and interference checking. Here we see a 3D isometric view of a selected sink, in white and yellow, with a code required clearance shown as a series of steps in red. The “steps,” which are a virtual code-specified element, must “fit” at and beneath the sink. Embodiments use 3D creation of elements to determine possible clearance or interference. Note that such requirements, in this example, cannot be verified using only 2D or textual information, such as elevations or plan views. Here, there is interference shown in pink between the code-required clearance and the physical sink.

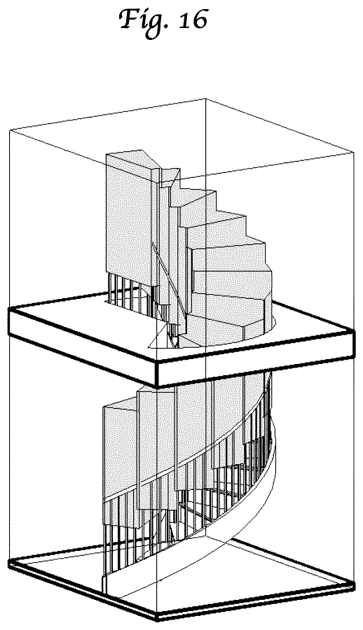

Turning now to FIG. 16, we see a screenshot of a second representative 3D model creations and 3D intersection and interference checking. Here we see a spiral staircase shown in black and white. It is necessary to check for minimum headroom, shown in yellow, at each stair.

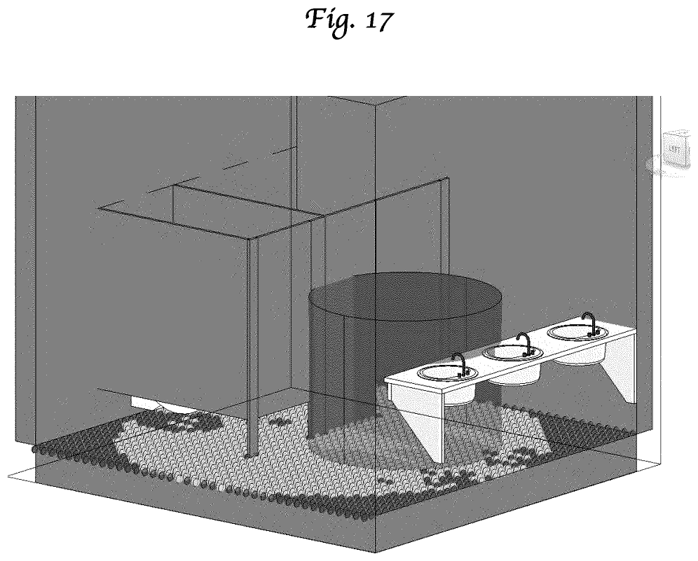

Turning now to FIG. 17, we see a screenshot of a third representative 3D model creations and 3D intersection checking. Here we see a wheelchair turning space requirement modeled as a red cylinder. Interference with the blue stall walls and with the white sinks are clearly visible. Interference is shown in maroon and pink.

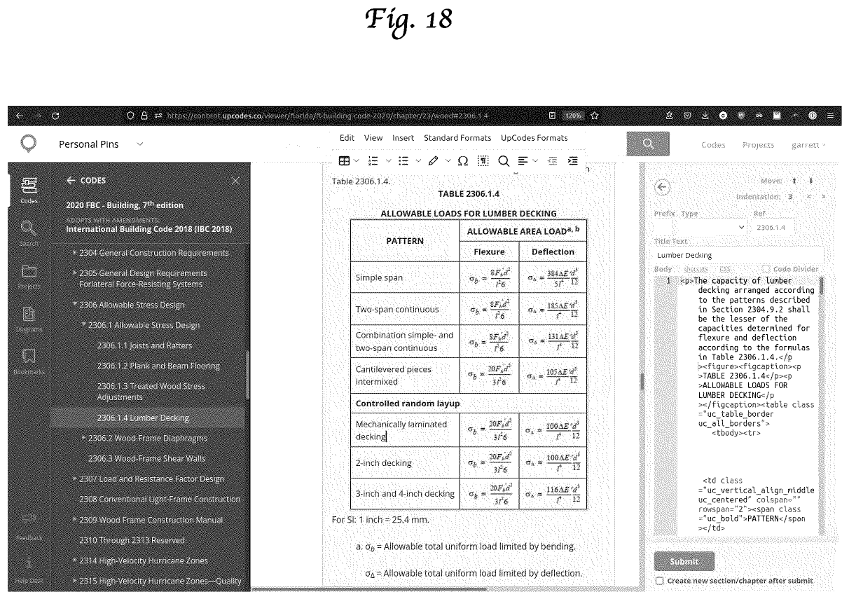

Turning now to FIG. 18, we see a screenshot of a representative Ingester. Ingester embodiments and method steps provide advanced validation up on submission, a WYSIWYG editor, and the ability to move sections around. This Figure shows the complexity of integrated related equations into a readable table.

An exemplary and non-comprehensive list of occupancy groups is: A-1, A-2, A-3, A-4, A-5, B, E, F-1, F-2, H-1, H-2, H-3, H-4, H-5, I-1, I-2, I-3, I-4, M, R-1, R-2, R-3, R-4, S-1, S-2, U.

An exemplary prior art source for computing a Levenshtein distance between two text strings is here: https://github.com/ztane/python-Levenshtein/blob/master/Levenshtein/_levenshtein.c #L715. [2023-10-06]

An exemplary use of one or more Levenshtein distances to compute a weighted ratio of similarity between two text strings (of lengths len_a and len_b respectively is:

$$( ( len\_a + len\_b ) + levenshtein\_distance ) / ( len\_a + len\_b ) .$$

The above equation generates a number in the range of zero to one, which may be viewed as a normalization for use in comparing similarities against a previously set or dynamically computed similarity threshold, such as 0.99 or 0.85.

Levenshtein distances are used inside of algorithms that compare text, section titles and section numbers. This and similar computations are sometimes called “edit distances.” An edit distance “score” may be computed with the equation, for example:

$$score = 1 - ( distance / length\_of \_fingerprint ) .$$

Distance is computationally determined, such as using a Levenshtein distance. A “fingerprint” is a block of text, titles, headings, numbers, figures and the like, in any combination. A fingerprint may also be a compressed or filtered version of an associated block. For example, punctuation, noise words, page numbers and the like may be first removed. The length_of_fingerprint is the number of characters in the fingerprint or a similar metric representing textual or graphical size. In one embodiment, a “distance” is computed by counting the number of occurrences of each character of two fingerprints and summing their difference. This may then be, normalized into the range of zero to one using the formula:

$$score = 1 - ( distance / length\_of \_fingerprint ) .$$

The text equivalent of section numbers may be “expanded” by replicating such numbers, or a portion of such numbers, by a predetermined or computed number of times within a fingerprint. For example, a section number of “3” may be replicated 1000 times, adding 999 more characters to a fingerprint. This is one form of “weighting” that may be used to provide more weight for some types of text than other types. A computed score may then be compared against a predetermined or computed threshold. For example, if a score is less than 0.995, then two sections being compared may be considered “substantively different.”

Threshold numbers, section numbers and other numbers below are exemplary.

An embodiment takes into account both section numbering and section content; the algorithm to find a corresponding section may be as follows:
Retrieve the section with the exact same reference in the destination.
Calculate string similarity threshold using linear interpolation: the threshold varies from 93 to 90 depending on the max length of the source section and destination section (90 for length <=175, 93 for >=280, and linear interpolated in between), as exemplary numbers.
Compare source text and destination text using Levenshtein distance.
   If Levenshtein distance is greater than a threshold
      and the titles of the sections' ancestors have a Levenshtein distance of >=55 (for example), and the titles reference the exact same occupancy groups, then identify this section as a corresponding match. Checking for the same occupancy groups is important; a difference in occupancy groups would represent only a minor difference in Levenshtein distance, but potentially indicate that the sections are very different. For example, if a section had the title “Requirements for I-1 Occupancies”, one would not want that title to correspond to a section titled “Requirements for I-2 Occupancies” even though only a single character has changed.
   Else, Levenshtein distance is less than the threshold; section texts do not closely match but may still correspond. If one section text converted into tokens is mostly a subset of the other's (as defined by a modified Levenshtein distance of e.g., 96), the sections have a Levenshtein distance of >=64, the titles of the sections' ancestors have a Levenshtein distance of >=75, and the titles reference the exact same occupancy groups, then declare this section a corresponding match. This captures cases where the text of one section is almost entirely a subset of the other, typically because one side added a large addendum to the section but left the start of the section unchanged. Thresholds herein are exemplary.
If no text match is made against the section with the exact same reference in the destination (or no such section exists), traverse the section hierarchy in the following manner and run the same comparison algorithm on each section in the order found:
   All children sections of the source section reference; e.g., if the source reference is 101.1, check 101.1.1, 101.1.2, etc.
   All sibling sections to the source section and their children; e.g., if the source reference is 101.1, check 101.2 and its children, check 101.3 and its children, etc.
   All immediate parent sections and their children; e.g., if the source reference is 101.1, check 101, 102, 103, etc.
   Immediately stop the search when a match is found.

This process may result in one-to-many corresponding sections; source section 101.1 might correspond with destination section 101.1, and source section 101 might also correspond with destination section 101.1. Since jurisdictions can and do split a single section in the source into multiple sections, this is something embodiments must consider.

If the entire corresponding process above is exhausted without a matching section, then that means there is no corresponding section in the destination code; that means the section was most likely deleted by the destination code, or so altered that it's not possible to determine the sections are the same without manual review.

Embodiments find the section in the destination code that represents the same section in the source code, but do not determine whether those two sections have identical requirements. If two sections have identical requirements, despite the text being slightly altered, we use the terminology for those two sections as not “substantively different.” Checking for substantive differences is important in building codes: if an architect is familiar with the requirements in 2015, they might want to know if the requirements changed in 2018. Thus, embodiments automatically checking the sections for substantive differences is a way to make this determination.

In some embodiment, a source document, section, text block or drawing may be swapped with a destination document, section, text block or drawing.

In some embodiments, drawings or figures may be included or treated as text. In some embodiments, text inside of drawings or figures may be used. In some embodiments, text recognition may be used to identify text. In some embodiments, footnotes, end notes, or other references in a text block either may or may not be used as part of the text block. In some embodiments, abbreviations may be replaced by the full text represented by the abbreviation. In some embodiments, a word or phrase may be replaced by an appropriate abbreviation. In some embodiments, text in a drawing or figure may be used as a text block. In some embodiments, only figures or drawings are compared.

In some embodiments, descriptions, claims, and figures may use a shortened phrase to mean an associated longer phrase. For example, “source hierarchical alphanumeric section heading” may be shortened to, “source section heading,” or “source alphanumeric heading, and the like.

In some embodiments capitalization is removed or ignored. In some embodiments punctuation is removed or ignored. In some embodiments, spelling correction is used.

Given two corresponding sections, perform the following method steps to determine if they are substantively different:
If the two section texts are identical character-for-character, sections are not substantively different.
If sections do not contain the same start clauses, where a “start clause” is defined as “For . . . ,” and “In . . . ,”, sections are substantively different. These clauses frequently indicate differences in requirements, e.g., the phrases “For smoke-protected assembly seating” and “For smoke-protected or open-air assembly seating” are very similar, but they do have different requirements that to be flagged.
If sections do not contain the same occupancy groups, sections are substantively different. For example, section one might say, “Groups R-1 and R-2 shall have two exits” and section two might say, “Group R-1 shall have two exits.” This is a minor text difference, but a substantively different requirement, so it would be flagged. Lists of occupancies using commas, “and”, “or” are all captured and parsed to catch all possible cases of occupancy group lists.
If sections have the same quantity of “autolinks”, delete the autolink content when performing the remainder of the algorithm. Else, do not delete the autolink content. “Autolinks” are hyperlinks added, appended, or associated to the section text; if two sections have an identical quantity of them, it is likely they are autolinks to the same sections and may be safely deleted by an embodiment and not considered for comparison. If they do not have an identical quantity, it's possible the sections are substantively different. For example, suppose section one has text, “See FIG. 1 for requirements” and section two has text, “See FIG. 1 and FIG. 2 for requirements”; “FIG. 1” and “FIG. 2” would both be converted into autolinks by embodiments. Since the sections have a different number of autolinks, the autolink content would not be deleted and the “Figure n” text would remain in comparison steps that follow.
Build a “fingerprint” of each section's text by:
   Prepending the section text with the title of the section.
   Removing HTML tags.
   Removing irrelevant characters; for example, one section may use the [′] character as an apostrophe and the other may use the [′] character; both are removed since differences could incorrectly throw off the substantive difference check.
   Removing references to jurisdictions; section one might reference “the Maryland Building Code” and section two might reference “the Florida Building Code”; this is not a substantive difference, since it is implied that the user of the output will know they are viewing sections from different jurisdictions.
   Converting each instance of a number into 1000 instances of that number. If the number “1” appears in a section, change it to 1000 “1” characters. This weights numbers very heavily in the comparison algorithm.
Compare the two fingerprints using a simple edit distance calculation: count the number of occurrences of each character in both fingerprints and sum their difference. Compute a zero to one score by subtracting this distance divided by the length of the fingerprint from 1:

$$score = 1 - ( distance / length\_of \_fingerprint )$$

Note that since each number is expanded to occur 1000 (e.g.,) times, any number difference between two fingerprints will trigger a very large edit distance difference. This is intended: differences in numbers very likely indicate a difference in requirements and should trigger the sections being substantively different.
If the score is <0.995 (e.g.,), then the sections are substantively different; else, they are not.

### Definitions

“Alphanumeric”—a string comprising any combination of digits, letters, and punctuation marks. In some cases, the term, “numeric” or “numerical,” may be used instead.

“Backbone building codes,”—as shown, master codes from which dependent codes or code sections are derived.

“Building Code”—means the definition as a term of art.

“Child section”—a section that is under a single parent section.

“Correspond”—a Levenshtein distance between two strings is less than a second threshold.

“Dependent building codes”—derived from a backbone code. For example, state codes.

“Levenshtein distance threshold”—a fixed or variable number.

“Levenshtein distance”—as known in the art. See, for example, Wikipedia.org, “Levenshtein.”

“Match”—Levenshtein distances between two strings is less than a first threshold.

“Occupancy group”—abbreviation letter for type of use, such as R for Residential, etc. There are 20-40 different occupancy groups by jurisdiction.

“Parent section”—a section that has one or more associated child sections under it.

“Section heading”—one or more strings associated with a single section.

“Section identifier”—a textual identifier associated with a single section.

“Section text”—one or more strings associated with a single section.

“Section title”—a single title associated with a single section.

“Section”—a block of text (strings) with one section number and one title.

“Set,” one or more, not none.

“Sibling sections”—one or more child sections under the same parent section.

“String”—an ordered group of any combination of sequential characters, numbers, punctuation, and words from a text block. In some applications, such computing a Levenshtein distance a second string may be produced from a first string by removing punctuation, plurals, jurisdictions, and “the” and “a.” Often, a string is a section text or section text block.

“Threshold”—A threshold, typically a scalar quantity, may be any appropriate predetermined number. Although values of specific thresholds may be provided, such as 0.995, claimed scope is broader, subject to no loss of clarity and with a determinism as required under 35 USC § 112. A person trained in the art would know or could determine without undue experimentation suitable values for thresholds.

Ideal, Ideally, Optimal and Preferred—Use of the words, “ideal,” “ideally,” “optimum,” “should” and “preferred,” when used in the context of describing this invention, refer specifically to a best mode for one or more embodiments for one or more applications of this invention. Such best modes are non-limiting and may not be the best mode for all embodiments, applications, or implementation technologies, as one trained in the art will appreciate.

All examples are sample or exemplary embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

Embodiments of this invention explicitly include all combinations and sub-combinations of all features, elements, and limitations of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification, abstract, and drawings. Embodiments of the methods of invention explicitly include all combinations of dependent method claim steps, in any functional order. Embodiments of the methods of invention explicitly include, when referencing any device claim or limitation thereof, to any and all other device claims, including all combinations of elements in device claims. Claims for devices and systems may be restricted to perform only the methods of embodiments or claims.

We claim:

1. A method of searching building codes comprising the steps:
identifying a first set of backbone building codes;
identifying a corresponding second set of dependent jurisdictional building codes for an each member of the set of backbone building codes;
identifying a sequence starting with a first step a first member of a second set of dependent building codes, continuing with the second step a corresponding member of the first set of backbone building codes, then continuing with the third step a second member of the set of backbone building codes, and terminating with step four a second member of a second set of dependent building codes associated with the corresponding second member of the set of backbone building codes; and
outputting the sequence.

2. The method of claim 1, wherein:
the identifying a sequence step uses as inputs at least: an alphanumeric section number in each of steps one through four, a corresponding alphanumeric section title in each of steps one through four, and a corresponding block of text in each of steps one through four.

3. A method of matching text sections, if any, from a source building code to a destination building code;
wherein the source building code comprises source hierarchical alphanumeric section headings and for each a corresponding source alphanumeric section title, a corresponding source section text block and a source set of occupancy groups;
wherein the destination building code comprises destination hierarchical alphanumeric section headings and for each a corresponding destination section title, a corresponding destination section text block and a destination set of occupancy groups;
comprising the following steps:
Accepting a first selected source hierarchical alphanumeric section heading;
Accepting a first destination hierarchical alphanumeric section heading matching the first selected source hierarchical alphanumeric section heading;
Computing a text block similarity threshold responsive to the length of the corresponding source section text block or the length of the corresponding destination section text block, or both;
Computing a title similarity threshold;
Computing a text block Levenshtein distance between the source section text block corresponding to the first selected source hierarchical alphanumeric section heading and the destination section text block corresponding to the first selected destination hierarchical alphanumeric section heading;
Computing a title Levenshtein distance between the source section title corresponding to the first selected source hierarchical alphanumeric section heading and the destination section title corresponding to the first selected destination hierarchical alphanumeric section heading;
Comparing the text block Levenshtein distance to the text block similarity threshold;
Comparing the title Levenshtein distance to the title similarity threshold;
Comparing the corresponding source set of occupancy groups to the corresponding destination set of occupancy groups;
Identifying the matching text sections, if any, responsive to the comparing in steps seven through nine; and
Outputting the first selected source hierarchical alphanumeric section heading responsive to the identifying, if any, from step ten.

4. A method of relating text sections, if any, from a source building code to a destination building code;
wherein the source building code comprises source hierarchical alphanumeric section headings and for each a corresponding source section title, a corresponding source section text block and a source set of occupancy groups;
wherein the destination building code comprises destination hierarchical alphanumeric section headings and for each a corresponding destination section title, a corresponding destination section text block and a destination set of occupancy groups;
comprising the following steps:
Accepting a first selected source hierarchical alphanumeric section heading;
Accepting a first destination hierarchical alphanumeric section heading matching the first selected source hierarchical alphanumeric section heading;
Accepting a first ancestor source alphanumeric section heading responsive to the first selected source hierarchical alphanumeric section heading;
Accepting a first ancestor destination alphanumeric section heading responsive to the first selected destination hierarchical alphanumeric section heading;
Computing a title similarity threshold;
Tokenizing the corresponding source section text block;
Tokenizing the corresponding destination section text block;
Computing if the tokenized corresponding source section text block is a subset of the tokenized corresponding destination section text block;
Computing a title Levenshtein distance between the corresponding first ancestor source alphanumeric section heading and the corresponding first ancestor destination alphanumeric section heading;
Comparing the title Levenshtein distance to the title similarity threshold;
Comparing the corresponding source set of occupancy groups to the corresponding destination set of occupancy groups;
Identifying the related text sections, if any, responsive to the computing and comparing in steps eight through eleven; and
Outputting the first ancestor source alphanumeric section heading and/or the first ancestor destination alphanumeric section heading.
